(19) United States
(12) Patent Application Publication
(10) Pub. No.: US 2011/0234212 A1
(43) Pub. Date: Sep. 29, 2011

(54) MAGNETIC FLUX LEAKAGE INSPECTION DEVICE

(76) Inventors: Benoit LEPAGE, Quebec City (CA); Chunyan Tricia LIU, Weston, MA (US)

(21) Appl. No.: 12/748,614

(22) Filed: Mar. 29, 2010

(51) Int. Cl. G01N 27/82

(52) U.S. Cl. 324/219

(57) ABSTRACT

Disclosed are a method and an improvement to the existing conventional magnetic flux leakage inspection device that employ some fixed magnets that are fixed inside the magnet yoke and some movably adjustable magnets, allowing their dipole orientation to be adjusted between 0° and 180° relative to that of the fixed magnets. A lever and gear set connected to the adjustable magnets can be operated to achieve desired level of magnetic strength of the device, including turning off the whole magnetic field, by causing the fields of the fixed and adjustable magnets to cancel each other. The disclosed adjustable yoke can also be used in other NDT/NDI applications where providing an adjustable magnetic strength is desirable.

### FIELD OF THE INVENTION

This invention relates to non-destructive testing and inspection (NDT/NDI) devices that employ magnetic fields induced by permanent magnets during the inspection, more particularly to an improved magnetic yoke which facilitates adjustment of the strength of the magnetic field in the devices.

### BACKGROUND OF THE INVENTION

It is known in the art, such as in U.S. Pat. No. 4,814,705 that discontinuities such as cracks or pits below the surface of a test object of magnetizable material can be detected by magnetizing the material and sensing variations in leakage field near the surface of the test object. The device disclosed in U.S. Pat. No. 4,814,705 utilizes one or more magnets and an array of magnetic flux leakage sensors which are moved over the surface of the test object in close proximity. When a local region of the test object under the magnet is free of defects, it produces an induced magnetic flux of a known form that is highly regular. Localized defects from corrosion, pitting and the like produce irregularities in the highly regular form of the flux pattern that “leaks out” of the test object. The irregularities in the otherwise regular flux pattern may be detected by sensors in the inspection device positioned just above the test object surface. This also applies to some applications wherein the defect producing the magnetic anomaly is on the inaccessible side of the test objects.

Typical magnetic flux leakage inspection devices include a carriage mounted on wheels that carries the magnet for inducing the magnetic field, the sensors for detecting the flux leakage, a motor for driving the wheels, and various other subassemblies needed for the device to function. To perform an inspection, the device is wheeled slowly across the test object surface while on-board sensors search a strip, typically about twelve inches wide, for magnetic leakage flux.

The typical “magnets” used by these inspection devices are of two kinds: permanent magnets or electromagnets, which both induce a magnetic field within the magnetizable test object. To achieve good inspection sensitivity and accuracy with respect to corrosive type defects, it is desirable to apply the largest possible magnetizing force to the test object. There is a practical limitation, however, to the magnitude of the largest magnetizing force that can be applied. That is the attractive magnetic force between the magnets in the device and the material being magnetized can become unmanageably large. If the inspection device is to be operable, it must strike a balance between the magnitude of the magnetization induced in the test object under inspection (a larger induced magnetization provides greater sensitivity to magnetic anomalies) and the strength of the magnetic attraction between the test object and the device (the larger magnetic attraction, the more it hinders maneuverability of the device).

Currently available magnetic inspection devices are generally difficult to operate. The devices are heavy, typically weighing 100 to 300 pounds (44 to 130 kilograms). The needed strength of the magnetic inspection power creates attraction between the on-board magnet(s) and the steel plate (test object), such as an oil tank bottom, making it very difficult to freely move the device over the inspection surface. Even with the on-board driving motor for the wheels, manipulating the device in the course of inspecting a full tank bottom can be a laborious operation. A storage tank having an 80 foot (25 m) diameter, for example, may take up to eight hours to inspect.

Maneuvering the device is laborious in part because the operator must first “break” the attractive magnetic force whenever it is desired to re-position the device for inspecting a new region of the test object, for example when a sidewall is reached, or to navigate the device around or over obstacles such as plate welds. Steel plate in the order of ¼ to ½-inch thick (6 to 12 millimeters) is commonly welded to the tank bottom to patch previously discovered damage. When the edge of such patchwork is encountered, the operator must manually urge the device over or around the welded edge to continue the inspection. Operators commonly find it burdensome to manipulate the device back and forth over the tank bottom when the total attractive force exceeds about 200 pounds (about 90 kilograms) and extremely difficult if not prohibitively exhausting when the attractive force exceeds about 700 pounds (about 300 kilograms).

Some eddy current inspection techniques make use of strong magnets to magnetically saturate ferromagnetic test objects. The existing magnetic yokes used for these devices are afflicted by the same inconveniences as the magnetic flux leakage inspection devices mentioned above, notably poor maneuverability, difficult cleaning and restricted air carrier transportation.

Prior efforts to alievate the maneuvuerbility problem include attempts to provide a foot pedal linked to the magnet assembly so that the operator may first displace the magnet away from the inspection surface by depressing the foot pedal to break the magnetic attraction. In practice, however, the foot pedal still leads to operator fatigue over the course of several hours of inspection. Consequently, operator fatigue places a practical limitation on the maximum magnetization that may be utilized, which in turn limits the sensitivity, accuracy and overall utility of the inspection device. Furthermore, the maximum magnetization limits the plate thickness that can be inspected and the size of the gap between the inspection device and the test object. The ability to inspect with a gap between the magnets of the device and the test object is important because tank floors are sometimes covered with fiberglass coating or paint coating.

Another effort attempted to overcome the maneuvrability problem due to strong permanent magnets by employing actuators to increase the distance between the permanent magnetic yoke and the inspection surface thereby decreasing the magnetic force to facilitate repositioning of the device. However, these attempts do not overcome the additional problems associated to the use of strong permanent magnets which include not being able to use ferromagnetic tools or other accessories in close proximity to the device.

Additional limitations of the known efforts related to the use of strong permanent magnets that caused metallic debris to tend to adhere to the magnets and the difficulties of removing this debris.

Furthermore, aviation transportation laws place limitation on the strength of the magnetic field of the equipment that can be shipped by air carriers. For many corrosion inspection service companies, this is a major limitation as shipping the inspection device by land carriers takes a significantly longer time.

Electromagnets can also be used in magnetic flux leakage apparatuses or with alternative eddy current based inspection techniques. For example, the SLOFEC (saturation low field eddy current) technique, often referred to by its trademarked name as the Kontroll Technik, uses electromagnets for applications that require a specific level of magnetization and therefore an adjustable magnetic field. These eddy current based inspection techniques that currently compete with magnetic flux leakage devices require a continuously variable magnetic strength to achieve a precise level of magnetization in the test object.

Although the electromagnetic field can be adjusted or completely turned off in these applications using electromagnets, electromagnets are significantly heavier than their permanent magnet counterparts and the power requirement is significant. Particularly, the high power requirement significantly affects the portability of these devices. The high amperage power requirement for electromagnets may also pose certain safety concerns.

Thus given the existing problems and tried efforts, it is highly beneficial to provide a permanent-magnet based magnetic flux leakage inspection device, in which the magnetic power can be easily adjusted, to achieve better maneuverability and inspection sensitivity while avoiding the drawbacks of electromagnets based devices.

It can also be appreciated that it is beneficial to provide other types of NDT/NDI devices involving permanent magnets with the capabilities of adjusting the power of their magnetic fields.

### SUMMARY OF THE INVENTION

The invention is related to NDT/NDI devices involving permanent magnets where such existing and conventional devices present the drawbacks and problems of having poor maneuverability, of being difficult to clean and being unsuitable for air transportation.

Accordingly, it is a general object of the present disclosure to provide an improvement to such devices as the conventional permanent magnet type of magnetic flux leakage inspection device by employing a mechanism to adjust the strength of the magnetic field during operations.

It is further an object of the present disclosure to employ an adjustable magnetic yoke to conveniently adjust the strength of the magnetic field during operations.

It is further an object of the present disclosure to make use of a combination of fixed and displaceable permanent magnets to provide a magnetic yoke which allows the magnetic field to be continuously adjusted.

In one embodiment of the current invention, a row of four permanent magnets are used to provide a combined magnetic field in a yoke wherein rotation of two of the magnets allows the strength of the magnetic field to be easily adjusted in a continuous fashion.

In another embodiment of the current invention, two rows of four permanent magnets (eight magnets in all) are used to provide a combined magnetic field in the yoke wherein rotation of two magnets of each row of the magnets allows the strength of the magnetic field to be easily adjusted in a continuous fashion.

It can be understood that the presently disclosed improvement to the existing magnetic flux inspection device provides the advantages of being easier to manipulate, clean and transport.

It can be further understood that the presently disclosed improvement to the existing magnetic flux leakage inspection device provides the advantages of improved sensitivity for the inspection device due to the capability of adjusting the device to provide magnetic strength at a desired level.

### BRIEF DESCRIPTION OF THE DRAWINGS

FIG. 1 is a schematic diagram showing a permanent-magnet-based magnetic flux leakage inspection device according to the present invention.

FIG. 2 is a schematic diagram showing an isometric view of one embodiment (embodiment A) of the inspection device according to the present invention.

FIG. 3 is a schematic diagram showing an isometric cross-sectional view of embodiment A.

FIGS. 4a and 4b are top cross-sectional views showing the arrangement of the permanent magnets of the preferred embodiment yielding variable magnetic power.

FIG. 5 is a schematic diagram showing an isometric view of an alternative embodiment according to the present invention.

FIG. 6 is a schematic diagram showing an isometric cross-sectional view of the alternative embodiment of the inspection device according to the present invention.

FIG. 7 is a schematic diagram showing an isometric cross-sectional view of the alternative embodiment according to the present invention.

### DETAILED DESCRIPTION OF THE INVENTION

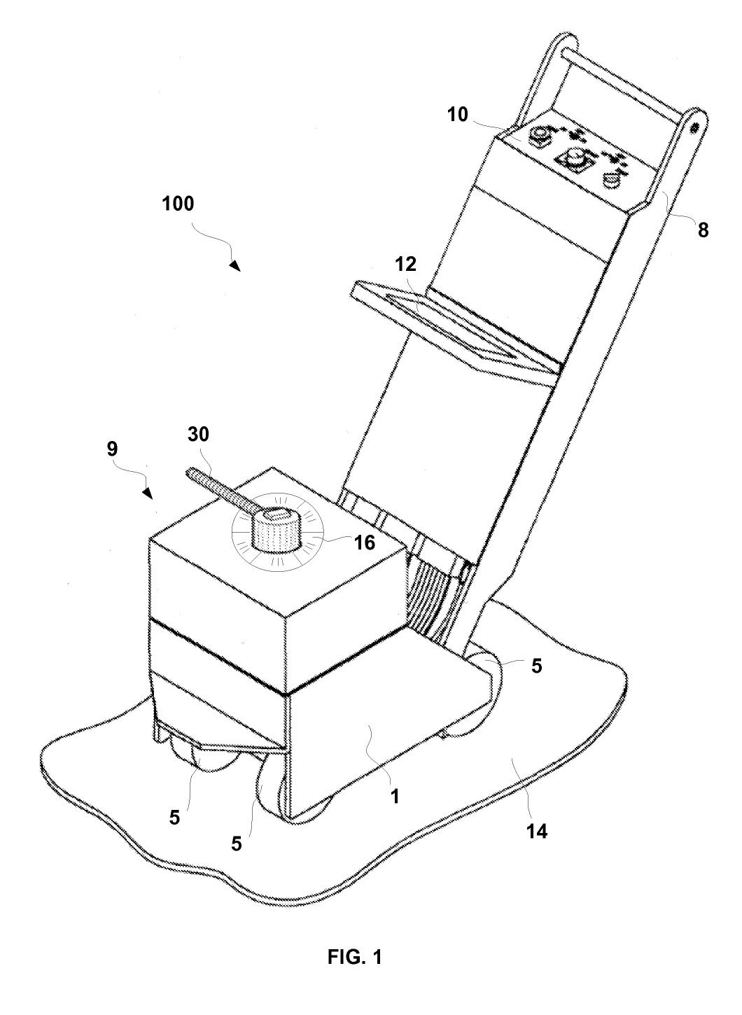

Referring to FIG. 1, one embodiment (embodiment A) of a magnetic flux leakage inspection device 100 according to the present invention is shown. The device includes an inspection carriage assembly 9 mounted on wheels 5 and a handle portion 8 by which an operator steers and manipulates the device. Preferrably mouted on handle portion 8 are a control panel 10 for controlling the operation of the device and an interface screen 12 for displaying inspection results and serving as an interface for the operator communicating with the device. The device is shown positioned on a portion of a test object 14, which is under inspection. Test object 14 is composed of a magnetizable material and for the case of storage tank bottoms, it is generally a ferromagnetic steel plate.

A novel aspect of device 100 representing a significant improvement to the existing magnetic flux leakage inspection devices is that device 100 comprises a scan bar assembly 1 containing a plurality of magnets, the orientation of which can be adjusted by a lever or knob type of actuator 30 so that the power of the magnetic field can be therefore easily adjusted.

Still referring to FIG. 1, lever 30 is configured so that its position corresponds to the orientation of the magnetic field of the magnets and the resulting overall magnetic strength of the device. A dial marking 16 is provided on top of the housing of the assembly carriage 9 and preferably surrounds lever 30 to indicate the position of the lever and the corresponding orientation of the magnetic field of the magnets, and therefore to give the reading of the magnetic strength of the device 100.

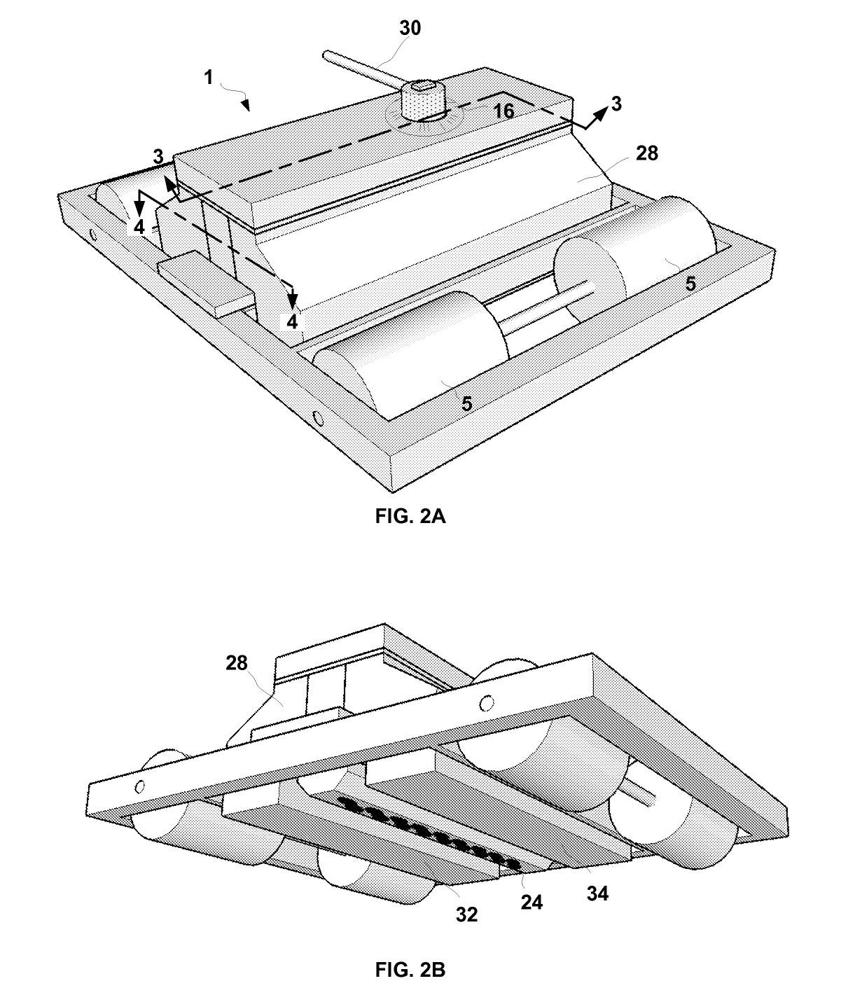

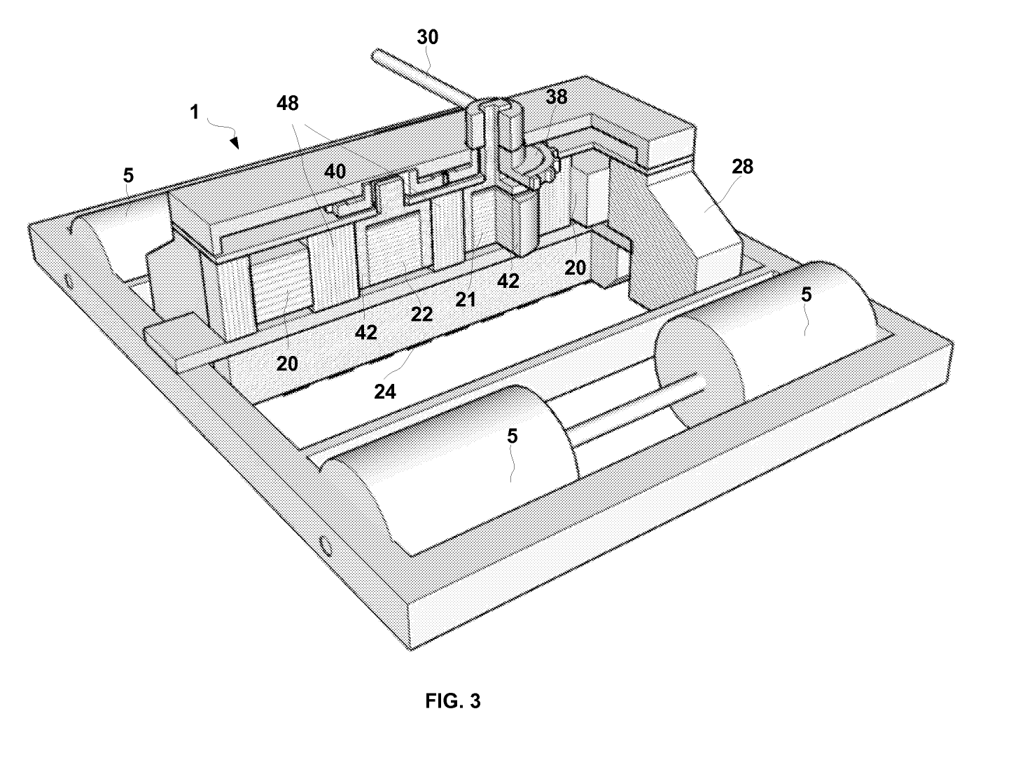

Referring now to FIGS. 2 to 4, more details of embodiment A, particularly of scan bar assembly 1 is shown. Carriage assembly 9 includes scan bar assembly 1 that is comprised of a yoke 28 that includes a row of preferrably four permanent magnets 20, 21 and 22 for inducing magnetization of plate 14 under inspection. Magnets 20 on the ends of yoke 28 are permanently embedded into yoke 28. Magnets 21 and 22 are linked together by gears 38 and 40 and are rotatable within yoke 28. The individual magnets 20, 21 and 22 are magnetically coupled to one another through yoke 28. Rotation lever or knob 30 are coupled to magnets 21 and 22. A locking mechanism is provided to lever 30 prevent magnets 21 and 22 from spontaneously returning to their nominal rotational positions.

Positioned beneath magnets 20, 21 and 22 and forming a part of scan bar assembly 1 is magnetic sensor assembly 24, which is used to detect magnetic leakage flux indicative of underlying magnetic anomalies associated with corrosive pitting and other plate damage.

When the magnetic dipole of magnets 20, 21 and 22 are aligned and disposed accordantly, yoke 28 is magnetically coupled to plate 14, a continuous magnetic circuit is formed.

More particularily shown in FIGS. 2A and 2B, for good measurement reliability it advantages important that yoke faces 32 and 34 which comprise the active sensor surface be disposed in an inspection position having a fixed distance from the surface of the plate 14 under inspection. The magnitude of the magnetization induced in plate 14 under inspection, and the magnitude of any consequent flux leakage due to an anomaly, depend on the distances of the yoke faces 32 and 34 from the testing surface of plate 14, and quantitative interpretation of measurement results depends on the positioning of magnetic probes 20, 21 and 22 in the leakage flux.

In operation, to inspect a strip of a tank bottom, the operator directs the device in a straight line over the strip. Wheels 5 are normally mounted to rotate only around their central axes in order to maintain the movement of the device in a generally straight line. The magnetic attraction between magnetic yoke 28 and plate 14 is generally quite strong. To maintain the movement against the resistive force of this magnetic attraction, wheels 5 are driven by a motor (not shown).

Rotation lever or knob 30 is provided for operator to apply a rotational force to magnets 21 and 22. This rotational force activates gear 38 which in turn activates gear 40 which provides synchronous rotation of magnets 21 and 22 in a rotational opposite direction. To facilitate maneuvering the device over and around obstacles and re-positioning in new directions, using rotation lever or knob 30 to apply a 180 degree rotation of the dipole of magnets 21 and 22 with respect to the dipole direction of magnets 20 produces a magnetic field cancelling effect that significantly reduces the strength of the magnetic force between yoke 28 and test object 14.

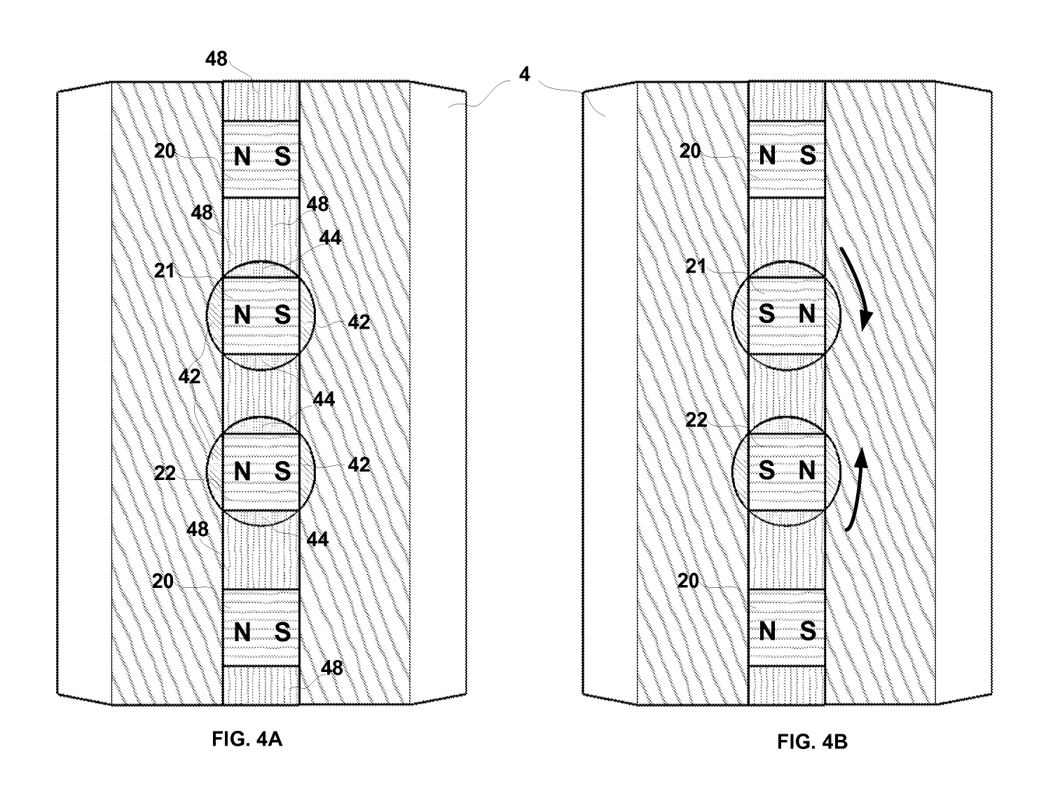

Referring specifically to FIG. 4A, the dipoles of magnets 20, 21 and 22 are aligned and disposed accordantly thereby producing a strong magnetic circuit. Referring to FIG. 4B, the dipoles of magnets 21 and 22 are aligned but disposed in opposite (180 degrees) direction of those of fixed magnets 20 thereby producing a very weak or null magnetic circuit. Rotation of the dipoles of magnets 21 and 22 by an angle between 0 and 180 degrees compared to the dipoles of magnets 20 produces a continuously variable magnetic field strength. Gears 38 and 40 produce an inverse rotational direction for magnets 21 and 22 which is an advantageous aspect of the invention, thereby contributing to a more uniform magnetic field in yoke 28.

It is worth noting that embodiment A uses cubic magnets. As shown in FIGS. 4A and 4B, field couplers 42 composed of ferromagnetic material such as carbon steel are employed by the embodiment. In order to properly produce a magnetic circuit in yoke 28, the dipole ends of cubic magnets 21 and 22 are fixed to field couplers 42. Field couplers 42 are solidly fixed to magnets 21 and 22 and rotate with magnets 21 and 22 within yoke 28. Note that the fixed magnets 20 are in direct contact with yoke 28 and directly produce magnetic circuit in yoke 28. In order to prevent short circuiting of the magnetic field with the rotation of magnets 21 and 22, these magnets are embedded in non-ferromagnetic magnet support 44. Fillers 48 are of non-ferromagnetic material and built in between magnets to block debris from entering yoke 28.

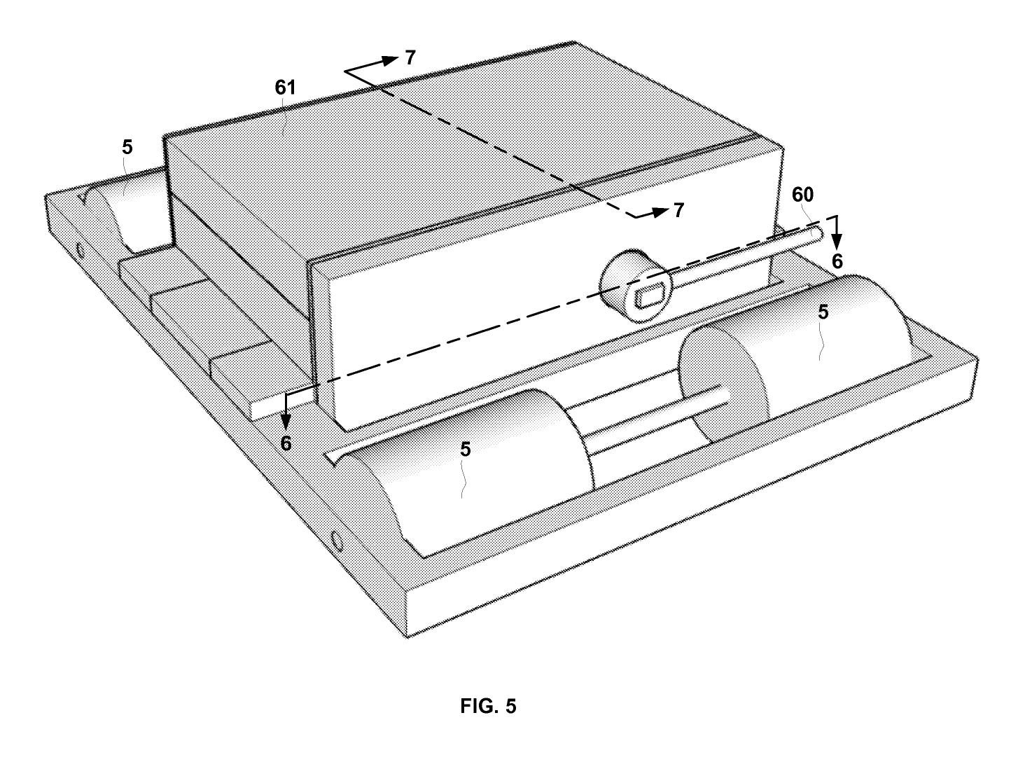

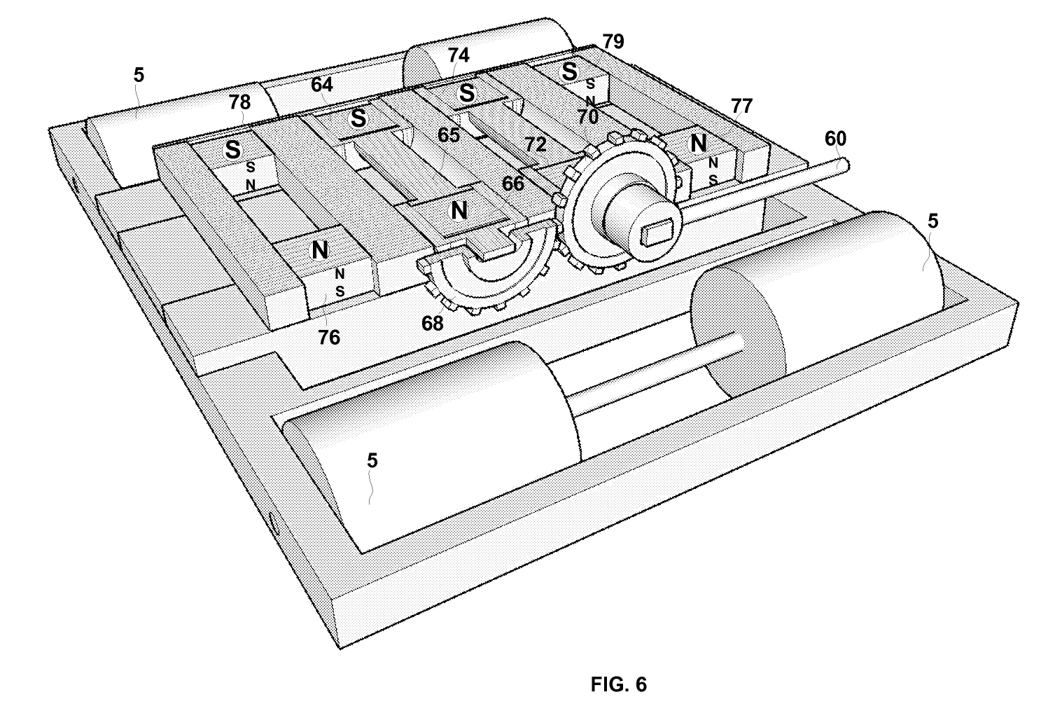

Reference now is turned to FIGS. 5 to 7, an alternative embodiment B of magnetic inspection device 100 with improved magnetic yoke is shown. It should be noted that the design variations from embodiment A should be recognized by those skilled in the art to be within the scope of the present disclosure. The detailed description of embodiment B focuses on the portion of the embodiments varied from embodiment A, and should be construed to complement embodiment A.

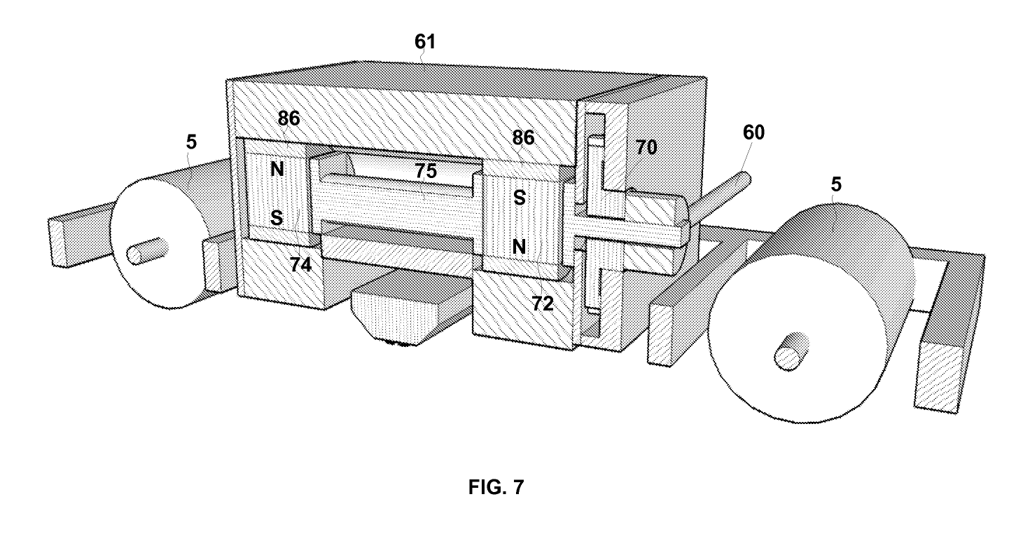

In embodiment B, as shown in FIGS. 5-7, an alternative yoke 61 is employed to replace yoke 28 of embodiment A. Yoke 61 embodies eight permanent magnets which are disposed in two rows, each row having four magnets. Magnets 76, 77, 78 and 79 are permanently fixed within yoke 61. Magnets 64, 66, 72 and 74 are disposed in between the permanently fixed magnets and can be rotated by activating a rotation lever or knob 60. Lever or knob 60, affixed to gear 70 provides direct rotation of magnets 72 and 74 and indirect rotation via gear 68 to magnets 64 and 66. Magnets 64 and 66 are embedded in non-ferromagnetic support 65. Non-ferromagnetic support 65 acts as an axle between magnets 64 and 66. As particularly shown in FIG. 7, a similar non-ferromagnetic support 75 is used for rotational magnets 72 and 74. Note that the embodiment employs the use of magnetic couplers 86 to provide a stronger magnetic connection between magnets 72, 74 and yoke 61. Note that the fixed magnets 76, 77, 78 and 79 are in direct contact with yoke 61 and directly produce a magnetic circuit in yoke 61.

The above descriptions and drawings disclose illustrative embodiments of the invention. Given the benefit of this disclosure, those skilled in the art will appreciate that various modifications, alternate constructions, and equivalents may also be employed to achieve the advantages of the invention.

For example, other configurations or other types and shapes of permanent magnets may be used. The invention is not limited to using four or eight magnets nor is the invention limited to using cubic magnets. Cylindrical magnets, annular magnets and other shapes can also be used.

In addition, the device may be configured with alternate means for rotating the rotatable magnets such as motorized means which may be controlled electronically. Other rotational means are possible beyond using gears such as using belts and chains.

Furthermore, it can be recognized that magnetic flux monitoring sensors such as Hall Effect sensors can be integrated into the magnetic yoke to monitor the actual magnetic field transmitted to the test object. These sensors can be linked to a user interface device by which the user can select the magnetic force required for a given inspection. Additionally, continuous adjustment of the strength of magnetic power according to the Hall Effect sensors helps provide constant magnetic flux during an inspection.

It is known in the art to use magnets to magnetize ferromagnetic test objects when performing eddy current inspections. It must be recognized that the adjustable magnetic yoke as disclosed herein would be beneficial for these inspections. In the case of eddy current inspections requiring complete saturation of the test object, the variable magnetic yoke provides the advantages of being easier to manipulate, clean and transport by air carriers. In the case of eddy current inspection techniques requiring partial magnetic saturation of the test object, such as SLOFEC, the novel adjustable magnetic yoke disclosed herein provides the advantage of being significantly lighter and more portable than electromagnets.

Although the most common application for magnetic flux leakage devices is the inspection of tank floors, it must be recognized that the invention herein can also be applicable to the magnetic flux leakage or eddy current inspection of tank walls, pipes and pressure vessels.

Although the novel aspect of adjustable magnetic yoke herein disclosed can also be advantageously applied to magnetic flux leakage or eddy current type inspection devices, it must be recognized that other uses are possible in the field of non-destructive testing. For example, inspection scanners for ferromagnetic test specimens employing ultrasound, phased-array, eddy current and other technologies would benefit from the use a permanent magnet arrangement for which the magnetic force can be adjusted. One can modify the existing use of magnetic wheels by adopting the herein disclosed adjustable magnetic yoke into such scanners. In this case, the suction force of the adjustable magnetic yoke is employed to maintain the scanner in contact with the inspection surface.

Although the present invention has been described in relation to particular exemplary embodiments thereof, many other variations and modifications and other uses will become apparent to those skilled in the art. It is preferred, therefore, that the present invention not be limited by the specific disclosure.

What is claimed is:

1. A magnetic yoke device useable for an NDT/NDI inspection device and having two or more magnets, wherein at least one of the magnets is a fixed magnet and at least one of the magnets is an adjustable magnet, wherein the adjustable magnet is configured to allow the orientation of its magnetic field to be adjusted, in a manner resulting in the strength of the overall magnetic field of the magnetic yoke being adjustable.

2. The device of claim 1, in which the device comprises a magnetic flux leakage inspection device which further comprises an actuator configured to adjust the orientation of the adjustable magnet to control the strength of the magnetic field of the yoke.

3. The device of claim 1, wherein the device is an eddy current inspection device which further comprises an actuator to adjust the orientation of the adjustable magnet to control the strength of the magnetic field of the yoke.

4. The device of claim 1, wherein the device is an ultrasonic inspection device, in which the magnetic yoke is configured to enable the attachment of the device to a test object and to allow the device to move over the object, the device further comprising an actuator to adjust the orientation of the adjustable magnet to control the strength of the magnetic field of the yoke.

5. A magnetic flux leakage inspection device suitable for inspecting magnetic flux leakage from a ferromagnetic surface comprising:
a wheeling mechanism configured to facilitate moving the device over a test surface;
a magnetic yoke comprising at least one fixed magnet and at least one adjustable magnets;
a magnet adjustment actuator connected to an adjustment gear;
a sensing element sensing magnetic flux from the surface;
a magnetic flux reporting element and a user interface element;
wherein the at least one adjustable magnet is engaged with the adjustment gear and upon activation of the actuator, the orientation of the magnetic field of the at least one adjustable magnet is adjusted resulting in the strength of the overall magnetic field of the device being adjustable.

6. The device of claim 5, further comprising a housing that houses the yoke and the gear, and the actuator being disposed on an external surface of the housing.

7. The device of claim 5, in which the at least one fixed magnet and the at least one adjustable magnets are arranged in a row of two fixed magnets and two adjustable magnets.

8. The device of claim 5, in which the at least one fixed magnet and the at least one adjustable magnets have substantially the same size and cubic shape.

9. The device of claim 5, in which the at least one fixed magnet and the at least one adjustable magnets have substantially the same size and cylindrical shape.

10. The device of claim 5, in which the at least one fixed magnet and the at least one adjustable magnets are configured in rows wherein each row has four magnets two of which are fixed magnets and two of which are adjustable magnets.

11. The device of claim 5, in which the magnet adjustment actuator is a lever or knob type element.

12. The device of claim 11, in which the lever or knob type element is configured so that its position corresponds to the orientation of the magnetic field of the adjustable magnets and the resulting overall magnetic strength of the device.

13. The device of claim 12, further comprising a dial marking on the housing and in close proximity to the lever to indicate the position of the lever, and therefore a reading of the magnetic strength of the device.

14. The device of claim 5, in which the magnet adjustment actuator is an electronically motorized actuator.

15. The device of claim 5, in which the at least one adjustable magnet is embedded in non-ferromagnetic magnetic support.

16. The device of claim 5, further comprising field couplers which are of ferromagnetic material and attached to the at least one adjustable magnet and moveable with the adjustable magnets.

17. A method of adjusting the strength of the magnetic field of a magnetic flux leakage inspection device comprising providing at least one fixed magnet and at least one adjustable magnet and adjusting the orientation of the magnetic field of the at least one adjustable magnet.

18. The method of claim 17, in which the at least one fixed magnet and the at least one adjustable magnet have substantially the same size and cubic shape.

19. The method of claim 17, in which at least one of fixed magnet and at least one adjustable magnet are located in a row and in close proximity to each other.

20. The method of claim 17, in which the at least one adjustable magnet is attached to an actuator and a gear set, facilitating the adjustment of the orientation of the magnetic field of the adjustable magnet.
